(19) United States
(12) Patent Application Publication
(10) Pub. No.: US 2007/0090235 A1
(43) Pub. Date: Apr. 26, 2007

(54) Tripod

(76) Inventors: Theodore B. Ziemkowski, Loveland, CO (US); Barry T. Phillips, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/257,829

(22) Filed: Oct. 24, 2005

(51) Int. Cl. F16M 11/32

(52) U.S. Cl. 248/163.1

(57) ABSTRACT

A tripod is configured with a body configured to match the shape and size of the bottom of a camera. The tripod body optionally includes recesses allowing the three legs to fold up into the body, resulting in a substantially planar bottom surface. The three legs, when extended, are independently positionable to give the user the flexibility to use the tripod on non-planar surfaces, and to allow some aiming of the camera.

### BACKGROUND OF THE INVENTION

Low light situations in photography often require long shutter speeds for proper exposure. As a general rule of thumb cameras may be carefully hand held for shutter speeds at or above the inverse of the focal length of the lens in mm, for capturing a sufficiently sharp image. For example, a camera with a 100 mm lens may be hand held for shutter speeds of 1/100 seconds or faster. If slower shutter speeds are necessary, the camera must be stabilized to prevent blurring of the image. Many photographers carry large tripods to provide this stability. However, full-size tripods are bulky, heavy, and expensive. Small tripods exist and many users will carry along a pocket (of backpacking) tripod. However, even these small tripods (when used with pocket digital cameras) take up a substantial amount of space, generally must be carried separate from the camera since when they are attached to the camera, they stick out and are not convenient for packing, and because of this may be easily forgotten.

### SUMMARY OF THE INVENTION

A tripod is configured with a body configured to match the shape and size of the bottom of a camera. The tripod body optionally includes recesses allowing the three legs to fold up into the body, resulting in a substantially planar bottom surface. The three legs, when extended, are independently positionable to give the user the flexibility to use the tripod on non-planar surfaces, and to allow some aiming of the camera.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIGS. 1A-1H show an example embodiment of a tripod including pin hinged tripod legs according to the present invention.

FIG. 1A is a top view of an example embodiment of a tripod according to the present invention.

FIG. 1B is a left view of an example embodiment of a tripod according to the present invention.

FIG. 1C is a right view of an example embodiment of a tripod according to the present invention.

FIG. 1D is a front view of an example embodiment of a tripod according to the present invention.

FIG. 1E is a back view of an example embodiment of a tripod according to the present invention.

FIG. 1F is a bottom view of an example embodiment of a tripod according to the present invention.

FIG. 1G is a lower perspective view of an example embodiment of a tripod according to the present invention.

FIG. 1H is an upper perspective view of an example embodiment of a tripod according to the present invention.

FIGS. 2A-2H show the example embodiment of a tripod including pin hinged tripod legs from FIGS. 1A-1H with the legs extended according to the present invention.

FIG. 2A is a top view of the example embodiment of a tripod from FIGS. 1A-1H with the legs extended according to the present invention.

FIG. 2B is a left view of the example embodiment of a tripod from FIGS. 1A-1H with the legs extended according to the present invention.

FIG. 2C is a right view of the example embodiment of a tripod from FIGS. 1A-1H with the legs extended according to the present invention.

FIG. 2D is a front view of the example embodiment of a tripod from FIGS. 1A-1H with the legs extended according to the present invention.

FIG. 2E is a back view of the example embodiment of a tripod from FIGS. 1A-1H with the legs extended according to the present invention.

FIG. 2F is a bottom view of the example embodiment of a tripod from FIGS. 1A-1H with the legs extended according to the present invention.

FIG. 2G is a lower perspective view of the example embodiment of a tripod from FIGS. 1A-1H with the legs extended according to the present invention.

FIG. 2H is an upper perspective view of the example embodiment of a tripod from FIGS. 1A-1H with the legs extended according to the present invention.

FIGS. 3A-3H show an example embodiment of a tripod including ball and socket hinged tripod legs according to the present invention.

FIG. 3A is a top view of an example embodiment of a tripod according to the present invention.

FIG. 3B is a left view of an example embodiment of a tripod according to the present invention.

FIG. 3C is a right view of an example embodiment of a tripod according to the present invention.

FIG. 3D is a front view of an example embodiment of a tripod according to the present invention.

FIG. 3E is a back view of an example embodiment of a tripod according to the present invention.

FIG. 3F is a bottom view of an example embodiment of a tripod according to the present invention.

FIG. 3G is a lower perspective view of an example embodiment of a tripod according to the present invention.

FIG. 3H is an upper perspective view of an example embodiment of a tripod according to the present invention.

FIGS. 4A-4H show the example embodiment of a tripod including ball and socket hinged tripod legs from FIGS. 3A-3H with the legs extended according to the present invention.

FIG. 4A is a top view of the example embodiment of a tripod from FIGS. 3A-3H with the legs extended according to the present invention.

FIG. 4B is a left view of the example embodiment of a tripod from FIGS. 3A-3H with the legs extended according to the present invention.

FIG. 4C is a right view of the example embodiment of a tripod from FIGS. 3A-3H with the legs extended according to the present invention.

FIG. 4D is a front view of the example embodiment of a tripod from FIGS. 3A-3H with the legs extended according to the present invention.

FIG. 4E is a back view of the example embodiment of a tripod from FIGS. 3A-3H with the legs extended according to the present invention.

FIG. 4F is a bottom view of the example embodiment of a tripod from FIGS. 3A-3H with the legs extended according to the present invention.

FIG. 4G is a lower perspective view of the example embodiment of a tripod from FIGS. 3A-3H with the legs extended according to the present invention.

FIG. 4H is an upper perspective view of the example embodiment of a tripod from FIGS. 3A-3H with the legs extended according to the present invention.

FIG. 5A is a front perspective view of the example embodiment of a tripod from FIGS. 3A-3H with the legs extended and mechanically coupled with a camera according to the present invention.

FIG. 5B is a rear perspective view of the example embodiment of a tripod from FIGS. 3A-3H with the legs extended and mechanically coupled with a camera according to the present invention.

FIG. 5C is a front view of the example embodiment of a tripod from FIGS. 3A-3H with the legs extended and mechanically coupled with a camera according to the present invention.

FIG. 5D is a right side view of the example embodiment of a tripod from FIGS. 3A-3H with the legs extended and mechanically coupled with a camera according to the present invention.

FIG. 6 is a flow chart of an example embodiment of a method to manufacture a tripod according to the present invention.

### DETAILED DESCRIPTION

This description of the preferred embodiments is intended to be read in connection with the accompanying drawings, which are to be considered part of the entire written description of this invention. In the description, relative terms such as “lower,” “upper,” “horizontal,” “vertical,” “up,” “down,” “top,” “bottom,” “left,” and “right” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected,” “coupled,” and “interconnected,” refer to a relationship wherein structures are secured or attached to one another either directly or indirectly through intervening structures, as well as both movable or rigid attachments or relationships, unless expressly described otherwise.

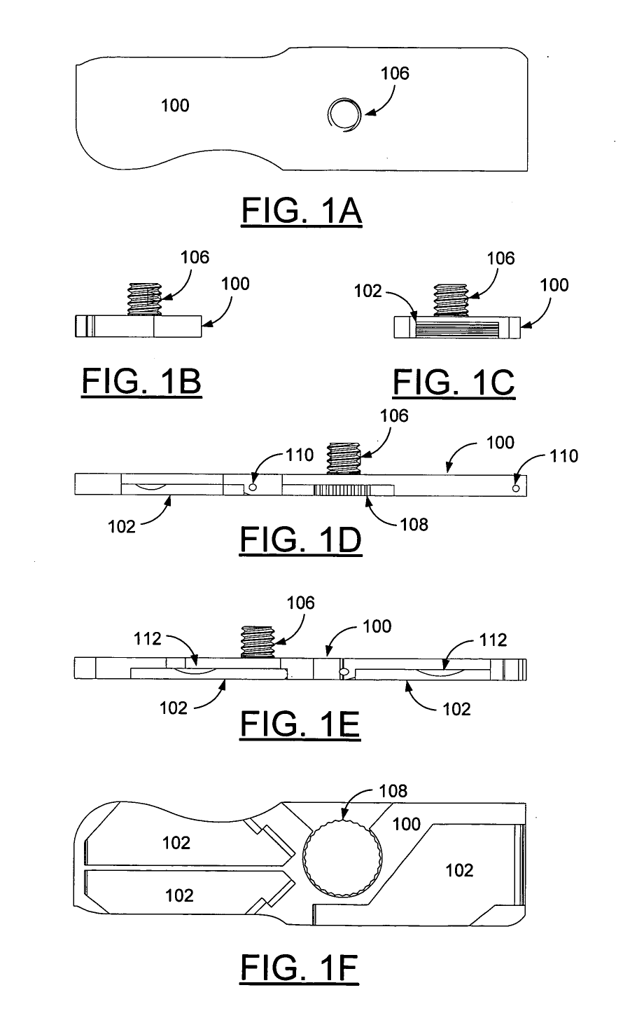

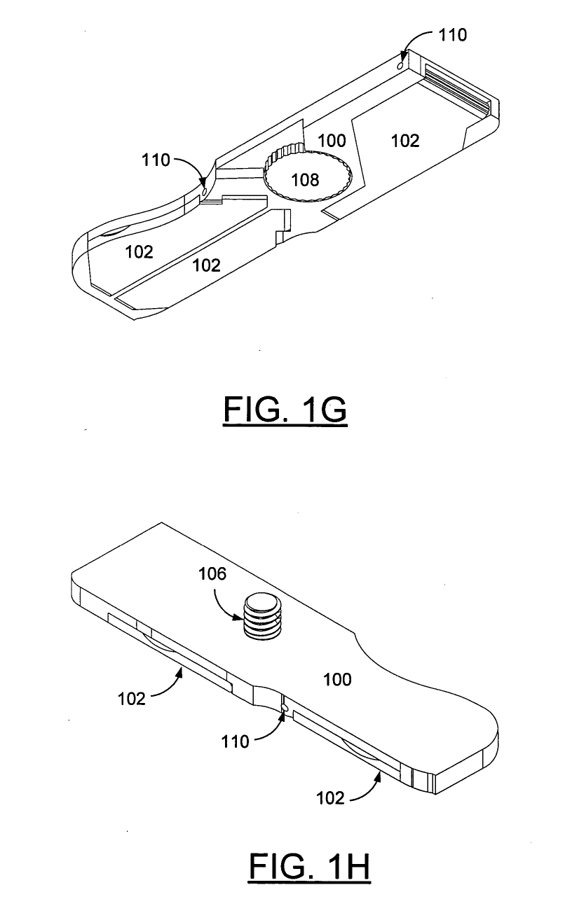

FIGS. 1A-1H show an example embodiment of a tripod including pin hinged tripod legs according to the present invention. In this example embodiment of the present invention a tripod is constructed comprising a tripod body 100 a tripod bolt 106 and three tripod legs 102. The tripod legs 102 are hingeably attached to the tripod body 100 by pins 110. These pins 110 are friction fit into holes in the tripod body 100 and the tripod legs 102 such that the tripod legs 102 may extend from the tripod body 100 at a plurality of angles while retaining sufficient strength to support a camera mechanically coupled to the top of the tripod body 100. In some embodiments of the present invention, the tripod legs 102 include fingernail recesses 112 configured to enable a user to extend the tripod legs 102 from the tripod body 100. The tripod bolt 106 is mechanically coupled with the tripod body 100 such that the bolt 106 may be rotated to tighten or loosen the tripod to a camera while remaining attached to the tripod body 100 when the tripod is removed from the camera. This feature may be realized with a groove in the tripod bolt 106 and a tab or lock ring within the tripod body 100. Those of skill in the art will recognize that this feature is optional and may be realized in a wide variety of ways all within the scope of the present invention. In an example embodiment of the present invention, the tripod bolt 106 includes a knurled head 108 allowing a user to tighten or loosen the tripod to a camera without the use of tools. Other methods of tightening or loosening the tripod bolt 106 may be used within the scope of the present invention.

FIG. 1A is a top view of an example embodiment of a tripod according to the present invention. The top surface of the tripod head 100 is configured to mate to the bottom surface of a camera and to match the horizontal extent of the bottom surface of the camera. This allows the tripod to be attached to a camera without extending out beyond the horizontal extent of the camera. The thickness of the tripod body 100 will add to the vertical extent of the camera, however, the footprint of the camera will remain unchanged with the tripod attached, allowing easy storage of the camera with the tripod attached. This feature enables users to leave the tripod affixed to the camera without significant penalty in storage space.

FIG. 1B is a left view of an example embodiment of a tripod according to the present invention.

FIG. 1C is a right view of an example embodiment of a tripod according to the present invention.

FIG. 1D is a front view of an example embodiment of a tripod according to the present invention.

FIG. 1E is a back view of an example embodiment of a tripod according to the present invention.

FIG. 1F is a bottom view of an example embodiment of a tripod according to the present invention.

FIG. 1G is a lower perspective view of an example embodiment of a tripod according to the present invention.

FIG. 1H is an upper perspective view of an example embodiment of a tripod according to the present invention.

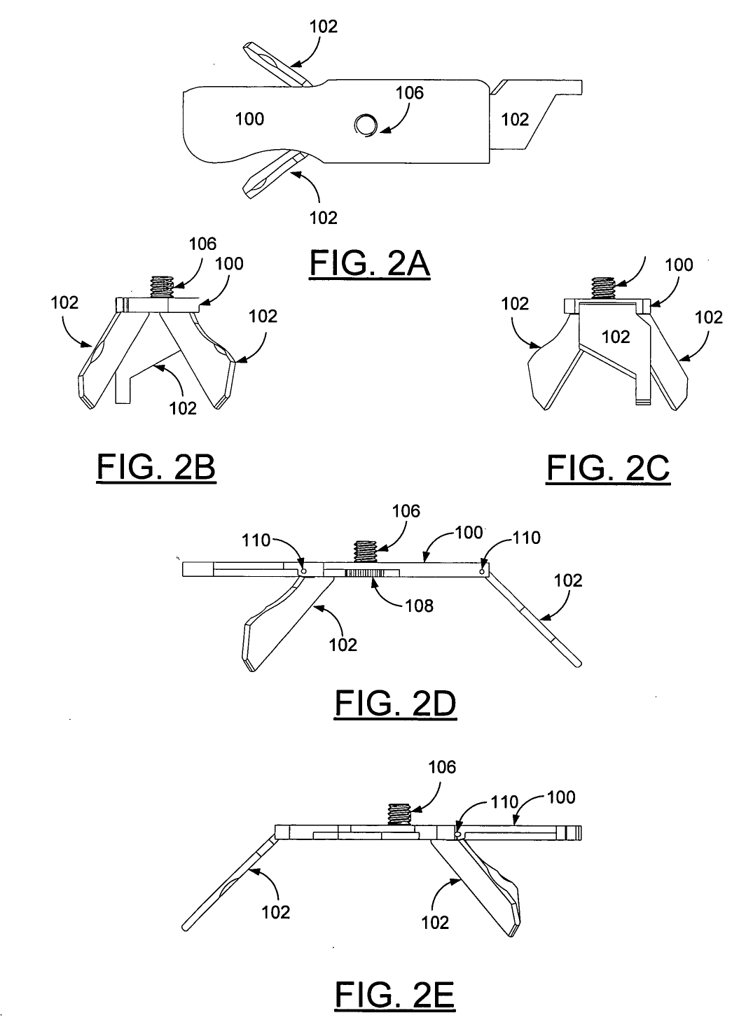

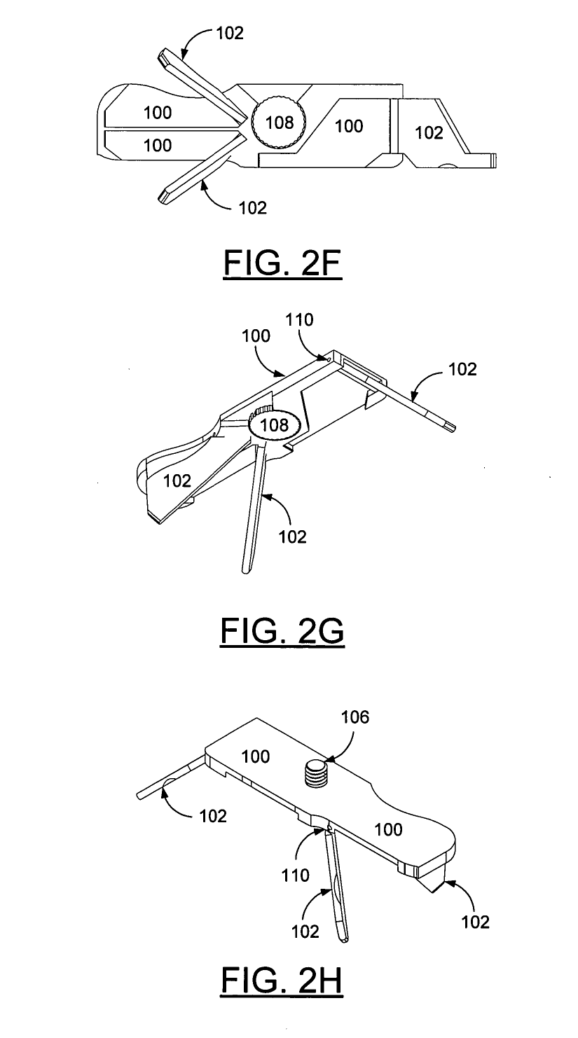

FIGS. 2A-2H show the example embodiment of a tripod including pin hinged tripod legs from FIGS. 1A-1H with the legs extended according to the present invention.

FIG. 2A is a top view of the example embodiment of a tripod from FIGS. 1A-1H with the legs extended according to the present invention.

FIG. 2B is a left view of the example embodiment of a tripod from FIGS. 1A-1H with the legs extended according to the present invention.

FIG. 2C is a right view of the example embodiment of a tripod from FIGS. 1A-1H with the legs extended according to the present invention.

FIG. 2D is a front view of the example embodiment of a tripod from FIGS. 1A-1H with the legs extended according to the present invention.

FIG. 2E is a back view of the example embodiment of a tripod from FIGS. 1A-1H with the legs extended according to the present invention.

FIG. 2F is a bottom view of the example embodiment of a tripod from FIGS. 1A-1H with the legs extended according to the present invention.

FIG. 2G is a lower perspective view of the example embodiment of a tripod from FIGS. 1A-1H with the legs extended according to the present invention.

FIG. 2H is an upper perspective view of the example embodiment of a tripod from FIGS. 1A-1H with the legs extended according to the present invention.

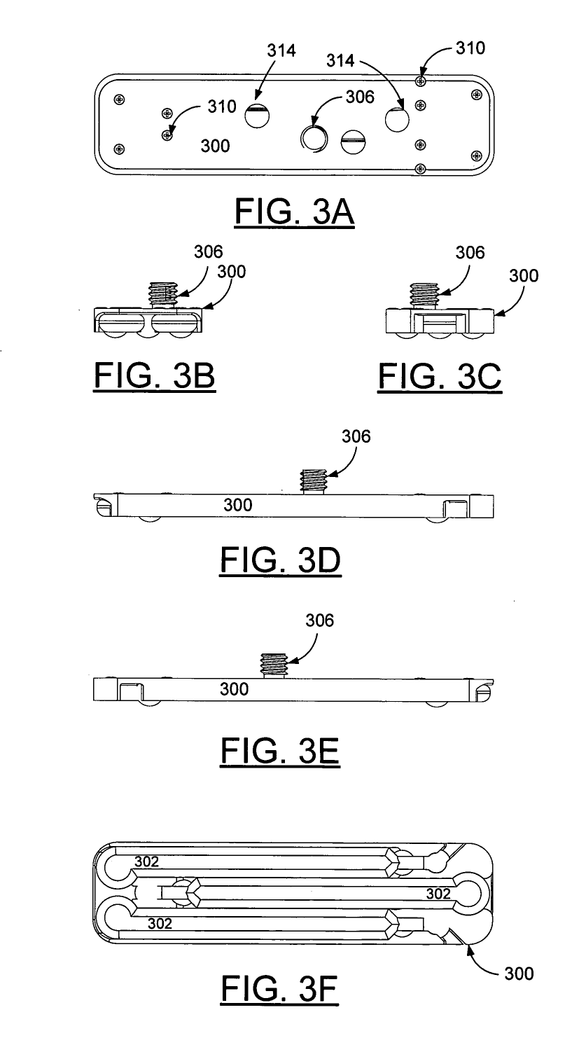

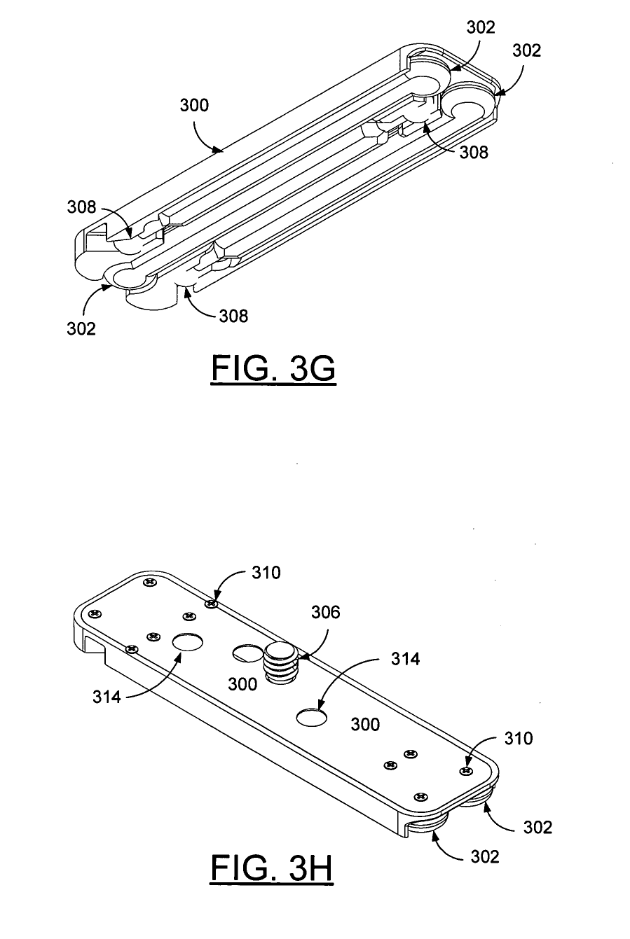

FIGS. 3A-3H show an example embodiment of a tripod including ball and socket hinged tripod legs according to the present invention. In this example embodiment of the present invention a tripod is constructed comprising a tripod body 300 a tripod bolt 306 and three tripod legs 302. The tripod legs 302 are hingeably attached to the tripod body 300 by ball and socket joints 308. These ball and socket joints 308 are configured to friction fit with the tripod legs 302 such that the tripod legs 302 may extend from the tripod body 300 at a plurality of angles while retaining sufficient strength to support a camera mechanically coupled to the top of the tripod body 300. In this example embodiment of the present invention, the sockets of the ball and socket joints are mechanically coupled with the tripod body 300 by a plurality of small screws 310. Other embodiments may use other configurations of the hinge joint all within the scope of the present invention. The tripod. bolt 306 is mechanically coupled with the tripod body 300 such that the bolt 306 may be rotated to tighten or loosen the tripod to a camera while remaining attached to the tripod body 300 when the tripod is removed from the camera. This feature may be realized with a groove in the tripod bolt 306 and a tab or lock ring within the tripod body 300. Those of skill in the art will recognize that this feature is optional and may be realized in a wide variety of ways all within the scope of the present invention. The tripod body 300 in this example embodiment of the present invention also includes a number of extra tripod bolt holes 314. A family of cameras may have the same bottom footprint, but may have the tripod hole in different locations. By providing extra tripod bolt holes 314, the tripod bolt 306 may be placed in the proper bolt hole 314 for a particular camera model while allowing use of the tripod with other camera models. In an example embodiment of the present invention, the tripod bolt 306 includes a slotted head 312 allowing a user to tighten or loosen the tripod to a camera with a screwdriver or small coin. Other methods of tightening or loosening the tripod bolt 306 may be used within the scope of the present invention.

FIG. 3A is a top view of an example embodiment of a tripod according to the present invention. The top surface of the tripod head 300 is configured to mate to the bottom surface of a camera and to match the horizontal extent of the bottom surface of the camera. This allows the tripod to be attached to a camera without extending out beyond the horizontal extent of the camera. The thickness of the tripod body 300 will add to the vertical extent of the camera, however, the footprint of the camera will remain unchanged with the tripod attached, allowing easy storage of the camera with the tripod attached. This feature enables users to leave the tripod affixed to the camera without significant penalty in storage space.

FIG. 3B is a left view of an example embodiment of a tripod according to the present invention.

FIG. 3C is a right view of an example embodiment of a tripod according to the present invention.

FIG. 3D is a front view of an example embodiment of a tripod according to the present invention.

FIG. 3E is a back view of an example embodiment of a tripod according to the present invention.

FIG. 3F is a bottom view of an example embodiment of a tripod according to the present invention.

FIG. 3G is a lower perspective view of an example embodiment of a tripod according to the present invention.

FIG. 3H is an upper perspective view of an example embodiment of a tripod according to the present invention.

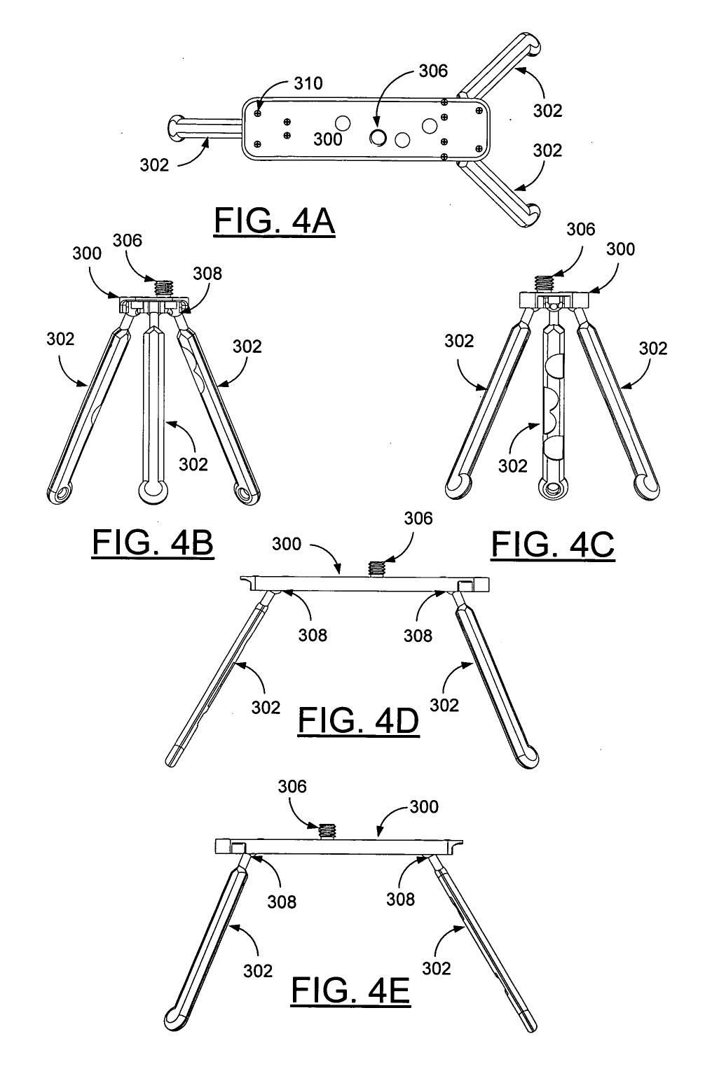

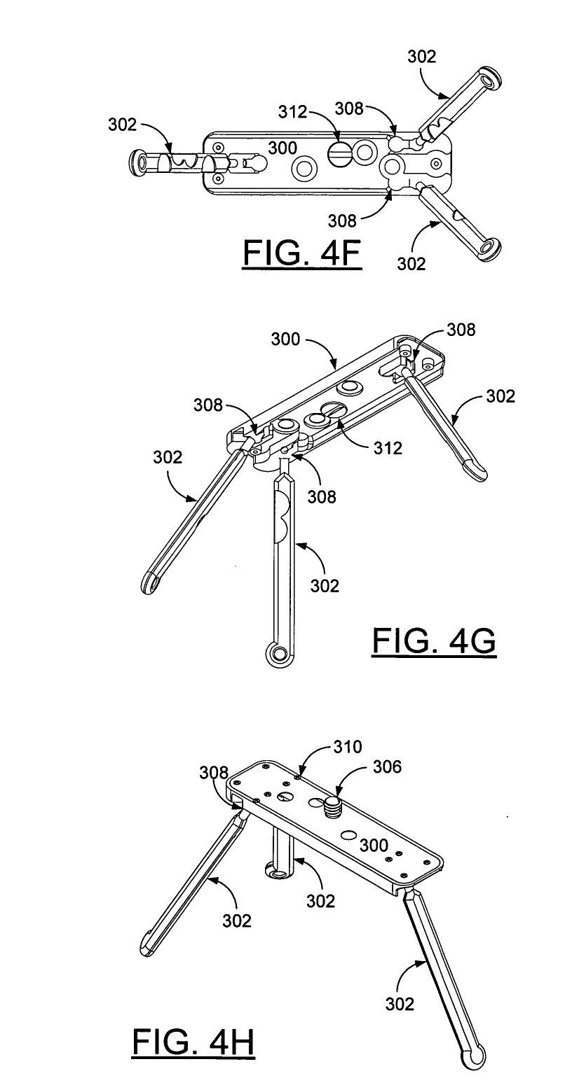

FIGS. 4A-4H show the example embodiment of a tripod including ball and socket hinged tripod legs from FIGS. 3A-3H with the legs extended according to the present invention.

FIG. 4A is a top view of the example embodiment of a tripod from FIGS. 3A-3H with the legs extended according to the present invention.

FIG. 4B is a left view of the example embodiment of a tripod from FIGS. 3A-3H with the legs extended according to the present invention.

FIG. 4C is a right view of the example embodiment of a tripod from FIGS. 3A-3H with the legs extended according to the present invention.

FIG. 4D is a front view of the example embodiment of a tripod from FIGS. 3A-3H with the legs extended according to the present invention.

FIG. 4E is a back view of the example embodiment of a tripod from FIGS. 3A-3H with the legs extended according to the present invention.

FIG. 4F is a bottom view of the example embodiment of a tripod from FIGS. 3A-3H with the legs extended according to the present invention.

FIG. 4G is a lower perspective view of the example embodiment of a tripod from FIGS. 3A-3H with the legs extended according to the present invention.

FIG. 4H is an upper perspective view of the example embodiment of a tripod from FIGS. 3A-3H with the legs extended according to the present invention.

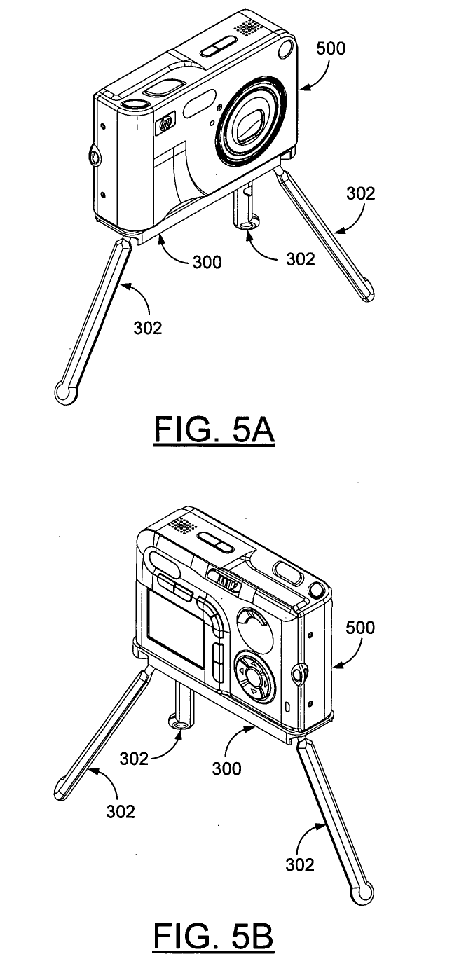

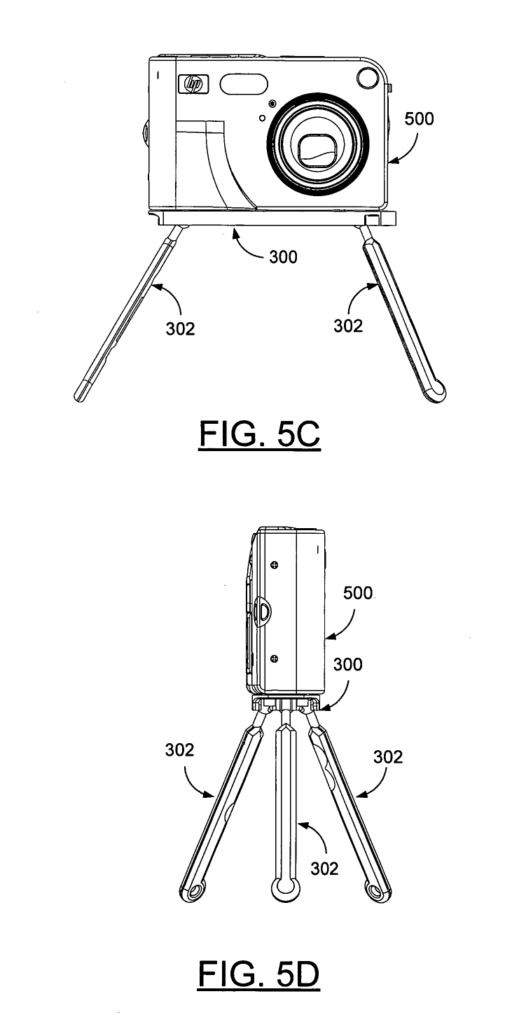

FIG. 5A is a front perspective view of the example embodiment of a tripod from FIGS. 3A-3H with the legs extended and mechanically coupled with a camera according to the present invention. Notice that the footprint of the tripod matches the footprint of the bottom surface of the camera 500, such that when the tripod legs 302 are not extended, the tripod does not extend beyond the horizontal extent of the camera. Also, since the tripod legs 302 are friction fit to the tripod body 300 they may be extended at a wide variety of angles with respect to the tripod body 300 while maintaining sufficient strength to support the camera 500.

FIG. 5B is a rear perspective view of the example embodiment of a tripod from FIGS. 3A-3H with the legs extended and mechanically coupled with a camera according to the present invention.

FIG. 5C is a front view of the example embodiment of a tripod from FIGS. 3A-3H with the legs extended and mechanically coupled with a camera according to the present invention.

FIG. 5D is a right side view of the example embodiment of a tripod from FIGS. 3A-3H with the legs extended and mechanically coupled with a camera according to the present invention.

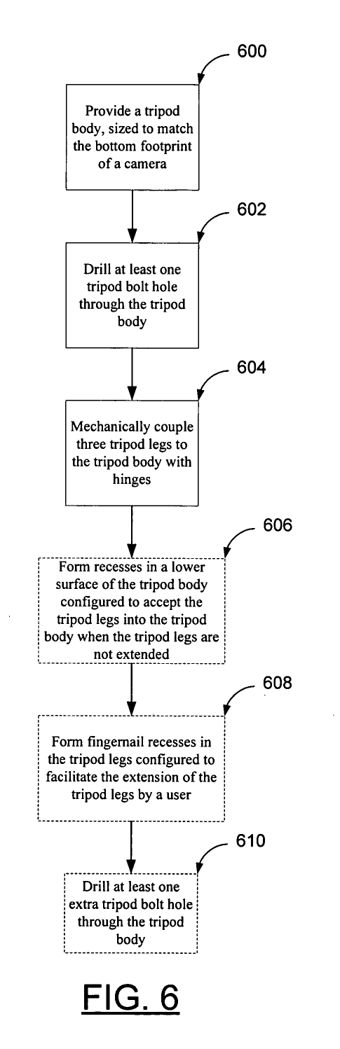

FIG. 6 is a flow chart of an example embodiment of a method to manufacture a tripod according to the present invention. In a step 600, a tripod body, sized to match the bottom footprint of a camera is provided. In a step 602, at least one tripod bolt hole is drilled through the tripod body. In a step 604, three tripod legs are mechanically coupled to the tripod body with hinges. In an optional step 606, recesses are formed in a lower surface of the tripod body and configured to accept the tripod legs into the tripod body when the tripod legs are not extended. In an optional step 608, fingernail recesses are formed in the tripod legs and configured to facilitate the extension of the tripod legs by a user. In an optional step 610, at least one extra tripod bolt hole is drilled through the tripod body.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A tripod comprising:
a tripod body, configured to match in extent the bottom footprint of a camera, including a tripod bolt hole;
a tripod bolt, mechanically coupled with said tripod body through the tripod bolt hole, and configured to mechanically couple a camera to said tripod body; and
three legs, each mechanically coupled with said tripod body through a hinge.

2. The tripod recited in claim 1,
wherein said hinges are pin hinges.

3. The tripod recited in claim 1,
wherein said hinges are ball and socket hinges.

4. The tripod recited in claim 1,
wherein said tripod body includes recesses in a lower surface configured to accept said tripod legs into said body when said tripod legs are not extended.

5. The tripod recited in claim 1,
wherein said hinges are friction fit such that said tripod legs may be extended at a plurality of angles with respect to said tripod body, while retaining sufficient strength to support the camera.

6. The tripod recited in claim 1,
wherein the camera is a digital camera.

7. The tripod recited in claim 1,
wherein said legs include fingernail recesses configured to facilitate the extension of said legs by a user.

8. The tripod recited in claim 1,
wherein said tripod bolt includes a knurled head.

9. The tripod recited in claim 1,
wherein said tripod bolt includes a slotted head.

10. The tripod recited in claim 1,
wherein said tripod body includes at least one extra tripod bolt hole.

11. A method for manufacturing a tripod, comprising the steps of:
a) providing a tripod body, sized to match the bottom footprint of a camera;
b) drilling at least one tripod bolt hole through the tripod body; and
c) mechanically coupling three tripod legs to the tripod body with hinges.

12. The method for manufacturing a tripod recited in claim 11,
wherein said hinges are pin hinges.

13. The method for manufacturing a tripod recited in claim 11,
wherein said hinges are ball and socket hinges.

14. The method for manufacturing a tripod recited in claim 11, further comprising the step of:
d) forming recesses in a lower surface of the tripod body configured to accept the tripod legs into the tripod body when the tripod legs are not extended.

15. The method for manufacturing a tripod recited in claim 11,
wherein said hinges are friction fit such that said tripod legs may be extended at a plurality of angles with respect to said tripod body, while retaining sufficient strength to support the camera.

16. The method for manufacturing a tripod recited in claim 11,
wherein the camera is a digital camera.

17. The method for manufacturing a tripod recited in claim 11, further comprising the step of:
d) forming fingernail recesses in the tripod legs configured to facilitate the extension of the tripod legs by a user.

18. The method for manufacturing a tripod recited in claim 11,
wherein said tripod bolt includes a knurled head.

19. The method for manufacturing a tripod recited in claim 11,
wherein said tripod bolt includes a slotted head.

20. The method for manufacturing a tripod recited in claim 11, further comprising the step of:
d) drilling at least one extra tripod bolt hole through the tripod body.

21. A tripod comprising:
means for supporting a camera;
means for mechanically coupling the camera to the means for supporting; and
means for mechanically coupling three legs to the means for supporting such that the legs are free to move about at least one axis while retaining sufficient strength to support the camera.
